(19) United States
(12) Patent Application Publication
(10) Pub. No.: US 2016/0144356 A1
(43) Pub. Date: May 26, 2016

(54) MICROPIPET FOR ALIQUOTING SMALL VOLUMES OF FLUID

(71) Applicant: WATERS TECHNOLOGIES CORPORATION, Milford, MA (US)

(72) Inventors: Moon Chul Jung, Waltham, MA (US); Pamela J. Longenbach, Northborough, MA (US); Pamela C. Iraneta, Brighton, MA (US); Kevin D. Wyndham, Upton, MA (US)

(21) Appl. No.: 14/898,295

(22) PCT Filed: May 7, 2014
(86) PCT No.: PCT/US14/37074

§ 371 Date: Dec. 14, 2015

Related U.S. Application Data
(60) Provisional application No. 61/835,866, filed on Jun. 17, 2013.

(51) Int. Cl. B01L 3/02

(52) U.S. Cl. CPC B01L 3/022; B01L 2300/0838; B01L 2400/0478; B01L 2200/0689

(57) ABSTRACT

Described is a pipet, or micropipet, that can be used to dispense multiple aliquots of a biological fluid sample. The pipet includes a capillary tube, a plunger and a plunger stop mechanism having multiple stop positions that allow the plunger to move through the capillary tube in equal incremental steps. The plunger stop mechanism enables the pipet to dispense equal volume portions of fluid in the capillary tube. Advantageously, the pipet can be fabricated at low cost and may be provided as a single-use disposable device. The micropipet may be provided to users with a sample collection device such as a dried blood spot card having multiple collection regions. The pipet optionally includes a dispensing stage that maintains a predetermined separation between the tip of the pipet and a surface of a sample collection medium to limit wicking of the fluid when an aliquot is dispensed.

### RELATED APPLICATION

This application claims the benefit of the earlier filing date of U.S. Provisional Patent Application No. 61/835,866, filed Jun. 17, 2013 and titled “Micropipet for Aliquoting Small Volumes of Liquid,” the entirety of which is incorporated herein by reference.

### FIELD OF THE INVENTION

The invention relates generally to a small volume pipet, or micropipet. More particularly, the invention relates to a pipet for aliquoting small volumes of a biological fluid sample.

### BACKGROUND

Measuring concentrations of administered drugs and their metabolites in biological fluids, such as whole blood, plasma and serum, is important to understanding the efficacy and toxicological effects of the drugs. Typical clinical studies require handling and processing large numbers of biological fluid samples at low temperature with special care. Dried spot sampling is an alternative practice that is based on collection of small volumes (e.g., several microliters or less) of biological fluids as dried spots. For example, dried blood spot (DBS) sampling involves the collection of small volumes of blood onto a carrier medium. Samples are reconstituted and analyzed, for example, in a liquid chromatography-mass spectrometry assay.

Dried sample spot processing can be performed in multiple ways. Samples are reconstituted from the dried spots using suitable solvents during an extraction process. In one procedure, a small disc is punched from the DBS sample carrier (e.g., DBS card). Examples of this process are described in PCT Patent Publication No. PCT/US2013/043562, titled “Solid Phase Extraction Device for Dried Sample Cards. The punch step functions as a volume aliquoting of the DBS. A precise sample volume may not be obtained under certain conditions, such as when the subject hematocrit deviates from a normal value. In some instances, the punched disc includes only a small portion of the collected sample and much of the collected sample is therefore wasted. In some implementations, the punching step is a manual procedure that serves as a bottleneck for the analytical procedure.

Whole spot elution is an alternative to the punch procedure. The elution process is described, for example, in U.S. patent application Ser. No. 13/698,164, titled “Apparatus and Methods for Preparation and Analysis of Dried Samples of a Biological Fluid,” the contents of which are incorporated by reference herein.

The whole-spot extraction and elution procedures require precision in the sample spotting process. Any inaccuracy in the volume of sample fluid applied to the dried sample carrier can result in inaccurate results from subsequent analytical measurements.

Delivering a small volume of a biological fluid, such as blood or plasma, is challenging due to the high viscosity of the fluid. For example, the volume of a droplet of blood can be a few hundred microliters. In some analytical applications, it is desirable to utilize smaller volumes of blood, for example, as small as 5 microliters (μl) or less. Pipets are often used to collect small volume samples of biological fluids. A conventional pipet can fail to aspirate the desired sample volume. When dispensing the collected fluid from the pipet to a sample carrier, a significant amount of the collected fluid may be left behind at the tip of the pipet.

A sample collection capillary, such as a blood collection capillary, can be used to acquire a fluid sample and dispense the sample to a dried sample carrier. Sample collection capillaries are commonly in the form of a disposable glass tube. The tube may have a single volume marking; however, the tube generally cannot collect and dispense a quantitative volume of sample. Moreover, sample collection capillaries are not suitable for dispensing the collected sample in multiple aliquots. Thus sample collection capillaries are not practical for use with dried sample carriers having multiple collection regions.

### SUMMARY

In one aspect, the invention features a pipet that includes a capillary tube having a bore, a plunger, a plug and a plunger stop mechanism. The plunger has a shaft with a first end disposed in the bore of the capillary tube and a second end opposite the first end configured for depressing by a user. The plug is disposed on the shaft of the plunger inside the bore of the capillary tube and is in slidable engagement with a bore surface to provide a seal against the bore surface. The plunger stop mechanism is in cooperative engagement with the shaft of the plunger to limit movement of the shaft in an axial direction to equal incremental distances.

In another aspect, the invention features a pipet that includes a capillary tube having a bore, a plunger, a plug and a dispensing stage. The plunger has a shaft with a first end disposed in the bore of the capillary tube and a second end that is opposite the first end and configured for depressing by a user. The plug is disposed on the shaft of the plunger inside the bore of the capillary tube and is in slidable engagement with a bore surface to provide a seal against the bore surface. The dispensing stage has a cylindrical shape and surrounds a first portion of a length of the capillary tube. The dispensing stage has an end configured to engage a surface of a dispensing structure having an opening so that a second portion of the length of the capillary tube extends through the opening by a predetermined distance.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is an illustration of an embodiment of a pipet according to the invention.

FIG. 2A and FIG. 2B are a partial view and a cross-sectional end view, respectively, of another embodiment of a pipet according to the invention.

FIG. 3 is an illustration of another embodiment of a pipet according to the invention.

FIG. 4 is an illustration of a four-well device and a positioning cover that may be used with embodiments of the pipet.

FIG. 5 is an illustration of a four-well device that may be used with embodiments of the pipet.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

The following terminology is used in accordance with the associated definitions. The term “pipet” means a device for transporting a volume of a liquid. A “micropipet” refers to a pipet that can dispense a collected fluid ranging from a volume of less than one microliter (μl) to more than 1,000 μl. Although various embodiments are described herein as “micropipets,” “pipet” embodiments having similar construction can accommodate greater fluid volumes. In some embodiments, the pipet is described for use in acquiring and dispensing blood samples but it should be recognized that the pipet may be used to acquire and deliver aliquots of other biological fluids and fluids in general.

In brief overview, the invention relates to a pipet, or micropipet, that can be used to dispense multiple aliquots of an acquired fluid sample, such as a biological fluid sample. The pipet includes a capillary tube and a plunger. The capillary tube is filled with the fluid sample by capillary force or by withdrawing the plunger from the capillary tube to create a vacuum to draw in the fluid. A plunger stop mechanism having multiple stop positions allows the plunger to move further into the capillary tube through incremental axial distances of equal value. The plunger stop mechanism enables the pipet to dispense portions of the acquired volume of fluid with the dispensed portions having equal volumes.

Advantageously, the micropipet can be fabricated at low cost. Preferably, the micropipet is used as a disposable device that is discarded after a single use. The micropipet may be provided to users along with a sample collection device. By way of example, the micropipet is suitable as part of a kit that also contains a DBS card having multiple collection regions. The user uses the micropipet to acquire a single blood sample and subsequently aliquots the acquired sample onto the collection regions of the sample collection device with each collection region receiving the same volume of blood.

During a preferred dispensing procedure, the user depresses the plunger through the controlled incremental distance and a fluid droplet is formed at the end, or tip, of the capillary tube. The fluid droplet is allowed to touch the surface of the collection media. The micropipet can include an optional dispensing stage that maintains a predetermined separation between the tip of the micropipet and a surface of a sample collection device when the fluid is dispensed. The separation distance is selected to allow the droplet to touch the collection media surface without allowing the tip of the capillary tube to come in contact with the collection media. Thus wicking of fluid present inside the capillary tube into the collection media is avoided. Wicking, if allowed to occur, can draw additional fluid from the capillary tube and thus reduce the volume accuracy of the dispensed fluid.

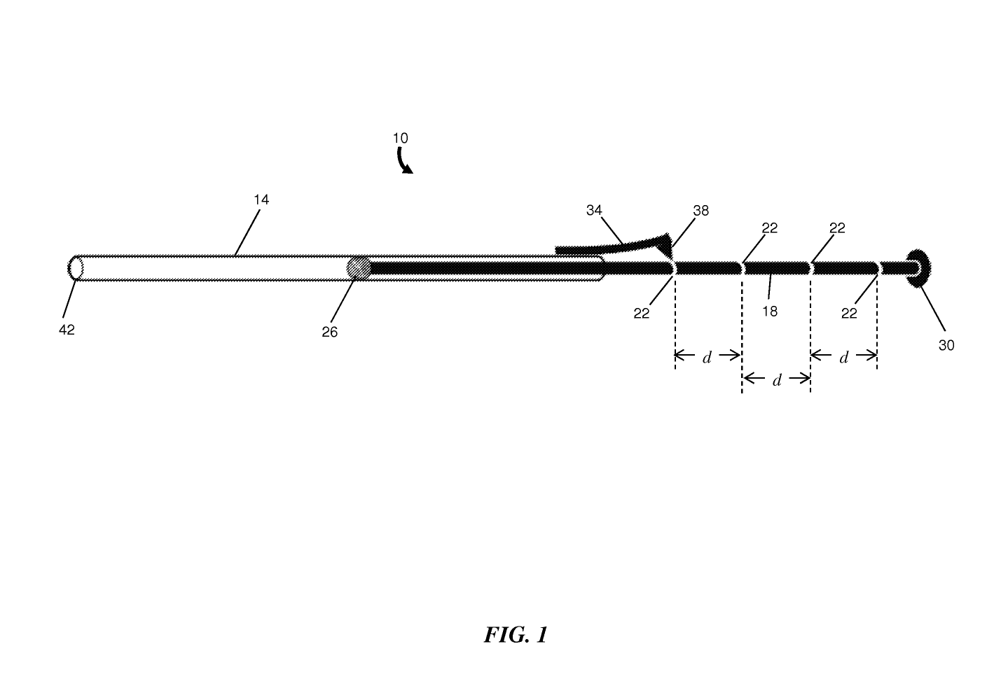

FIG. 1 shows an embodiment of a micropipet 10 according to the invention. The micropipet 10 includes a capillary tube 14 and a plunger. The plunger includes a shaft 18 having a diameter that is smaller than the diameter of the bore of the capillary tube 14 to allow the shaft 18 to be moved along the axis of the bore. A series of circumferential grooves 22 are present on the surface of the shaft 18. The axial separations d (i.e., separations along the axial length of the shaft 18) of all neighboring grooves are equal. A plug 26 is disposed at one end of the shaft 18. The plug 26 engages and provides a seal against the bore surface inside the capillary tube 14, and is adapted to slide along the bore surface as the plunger is depressed. The plug 26 may be attached to or integral with the shaft 18. The plug 26 can be in the form of a disc having a diameter approximately equal to the bore diameter. Alternatively, the plug 26 can have a different shape, such as a ball having a radius approximately equal to the bore diameter. A button 30 or other surface configured to receive the thumb or index figure of a user is provided at the end of the shaft 18 opposite to the plug 26. The button 30 allows a user to push or depress the shaft 18 further into the capillary tube 14.

The micropipet 10 also includes a plunger multi-stop mechanism to enable easy incremental motion of the plunger into the capillary tube 14 through equal distances d. The illustrated plunger stop mechanism is in the form of a spring-loaded plunger stop 34. One end of the plunger stop 34 is secured to the outer surface of the capillary tube 14. The other end of the plunger stop 34 has a tooth-like extension 38 shaped to engage one of the circumferential grooves 22 along the shaft 18. In other embodiments, the plunger multi-stop mechanism can have an alternative form as long as equal incremental plunger motions are achieved. For example, instead of circumferential grooves 22, the shaft can have saw-tooth variations in its radius arranged along the length of the shaft. The saw-tooth profile can be asymmetric to allow the extension 38 to easily pass over a saw-tooth profile as the plunger is inserted into the bore of the capillary tube 14 while preventing the shaft 18 from moving in the reverse direction.

To obtain a blood sample, the plunger is withdrawn from the capillary tube 14 until the plug 26 is near the end of the capillary tube 14 nearest to the plunger stop 34 so that the extension 38 “snaps into”, or engages, one of the grooves 22. Alternatively, the plunger is withdrawn further from the last groove 22 to create an internal volume larger than the desired sampling volume. The tip 42 of the capillary tube 14 is brought into contact with a source of blood so that a blood sample wicks up into the bore of the capillary tube 14 by capillary force. The blood source may be a patient or laboratory subject, or may be a container holding a previously-acquired blood sample. By way of a non-limiting numerical example, a capillary tube having an inner diameter of 0.033 in. can wick approximately 11 μl of blood when vertical. The volume of the blood sample that is acquired generally increases for orientations of the capillary tube that are increasingly more horizontal. The acquired volume can exceed 20 μl if the capillary tube is nearly horizontal.

To dispense the blood sample in the capillary tube 14, a user depresses the plunger so that the length of the shaft 18 inside the capillary tube 14 increases by the distance d and the extension 38 on the plunger stop 34 engages the next circumferential groove 22. Thus a small droplet of blood is dispensed at the tip 42 of the capillary tube 14.

For a whole-spot elution procedure, it is desirable to use spots obtained from approximately 5 μl of blood. If the volume of the acquired blood sample within the capillary tube 14 is substantially greater than 15 μl, the separations of the circumferential grooves 22 on the plunger shaft 18 can be selected to dispense three aliquots of 5 μl of blood.

It is common practice to run replicate samples in bioanalysis. Thus spotting collection devices with a “single stage” dispenser would require three dispensers for a single triplicate application; however, only one illustrated micropipet 10 is necessary for a single sampling (e.g., a single blood draw) and triplicate dispensing. In other embodiments, the number of aliquots that can be dispensed can be different. For example, a micropipet may be configured for four aliquots to allow for triplicate dispensing with a reserve aliquot for reanalysis of the sample at a later time. The illustrated micropipet 10 can be modified to dispense four aliquots by providing an additional circumferential groove 22 spaced a distance d from the first or last groove on the shaft 18.

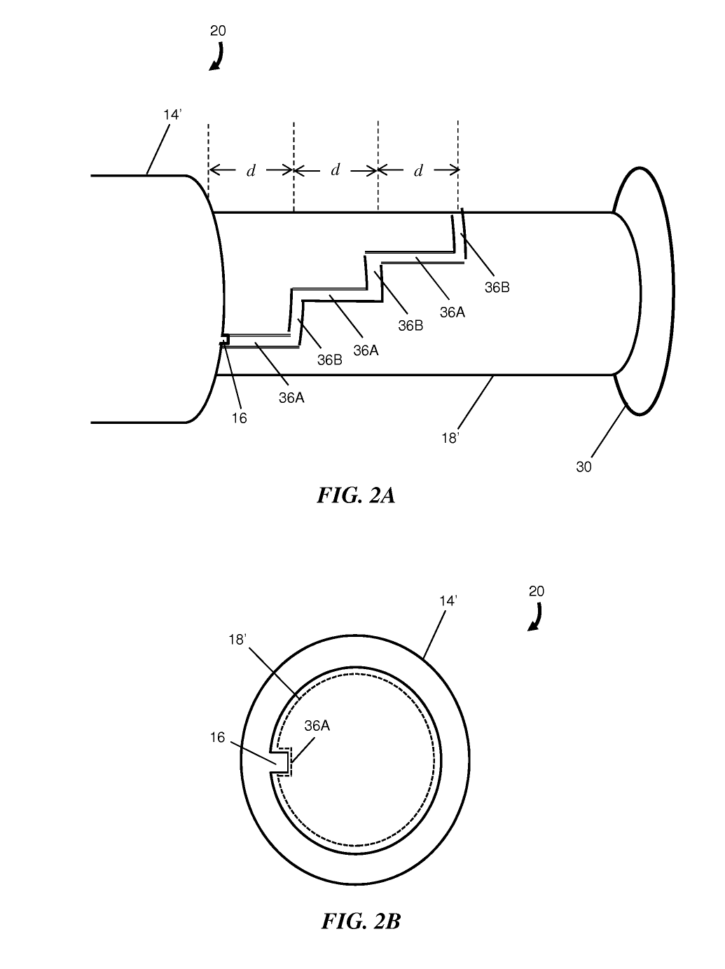

In another embodiment of a micropipet 20, as shown in the partial side view of FIG. 2A and cross-sectional end view of FIG. 2B, the shaft 18′ has a guide groove 36. The guide groove 36 includes longitudinal groove segments 36A connected by circumferential groove segments 36B. The capillary tube 14′ has a small extension 16 protruding radially inward that engages and slides within the guide groove 36. Although shown at one end of the capillary tube 14′, the extension 16 can alternatively be located in the bore of the capillary tube 14′. In another alternative embodiment, the extension 16 protrudes from a housing or other structure disposed over and fixed in position relative to the capillary tube 14′.

To dispense fluid from the micropipet 20, the plunger is twisted (rotated) to move the extension 16 to one end of a circumferential groove segment 36B, then the plunger is depressed through a distance d to provide an aliquot. Additional twisting and depressing of the plunger through additional distances d allows for additional aliquots of equal volume to be dispensed.

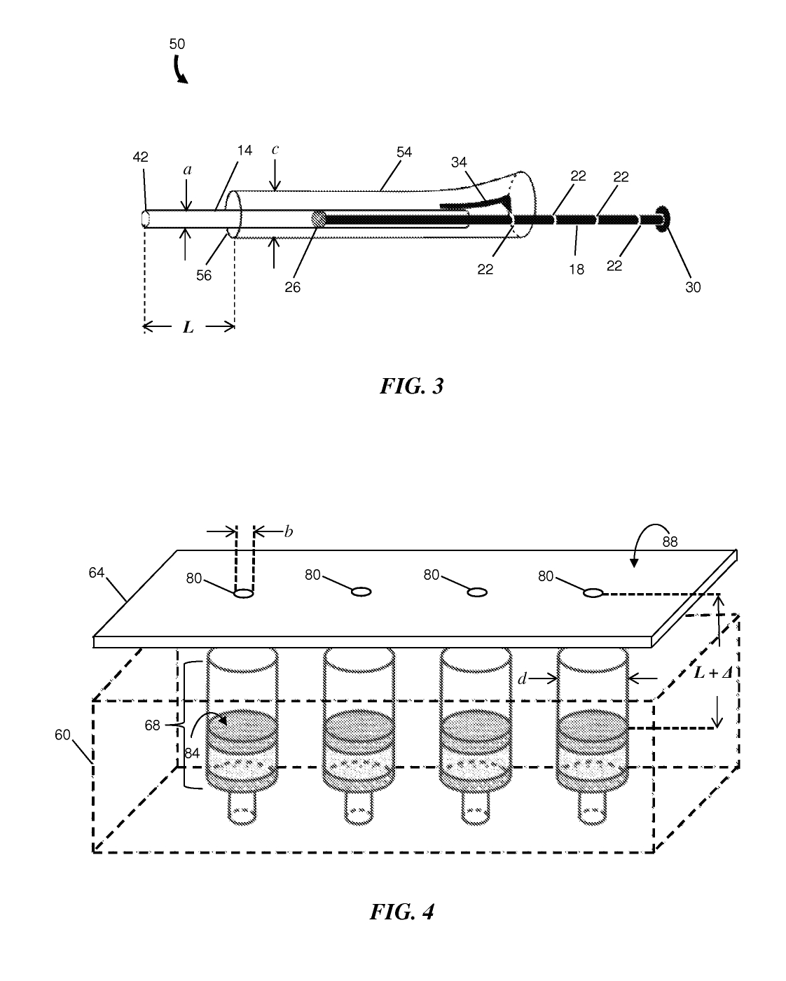

Referring again to FIG. 1, in order to preserve the capability of the micropipet 10 to deliver multiple aliquots of the collected blood, the tip 42 of the capillary tube 14 should not touch the absorbent collection media. Otherwise the highly absorbent collection media can wick extra blood from the capillary tube 14 and prevent precise aliquoting. Preferably, a droplet of blood is formed at the tip 42 of the capillary tube 14 by depressing the plunger through an axial distance corresponding to the distance d between adjacent circumferential grooves 22. A micropipet 50 may be configured with a dispensing stage as shown in FIG. 3 to prevent the tip 42 from coming into contact with the collection media. The dispensing stage is in the form of a substantially cylindrical case 54, or outer tube, that surrounds and is substantially coaxial with the capillary tube 14. The case 54 has an inner diameter sufficient to prevent interference with the plunger stop 34. The case 54 has a substantially greater outer diameter than the capillary tube 14 and thus enables the user to hold and maneuver the micropipet 50 easily. In other embodiments, the cross-section of the case 54 can be shaped differently. For example, the case 54 may have a rectangular or hexagonal cross-section. Preferably the micropipet 50 is operated with a single hand. For example, the user grasps the case with the thumb and middle finger while depressing the plunger button 30 with the index finger.

A length L of the capillary tube 14 extends from the end of the case 54 which acts as part of a positioning mechanism to prevent the tip 42 of the capillary tube 14 from contacting the collection media. Referring to FIG. 4, a four-well device 60 is shown underneath a dispensing structure in the form of a positioning cover 64. The outer structure of the four-well device 60 is depicted with dashed lines so that the wells 68 are visible. The positioning cover 64 is in the form of a plate, preferably with alignment features (not shown) such as registration pins, so that each of four openings 80 between the upper and lower cover surfaces are positioned above a respective one of the four wells 68. Optional spacers may be used between the positioning cover 64 and the top of the four-well device 60 to achieve a desired separation L+Δ between the top of the positioning cover 64 and the top of the collection media 84. With additional reference back to FIG. 3, the outer diameter a of the capillary tube 14, the diameters b of the openings 80, the outer diameter c of the case 54 and the diameter d at the top of the wells 68 are selected so that the case diameter c is greater than the opening diameters b which are greater than the outer diameter a of the capillary tube 14. In addition, the diameter b of each opening 80 does not exceed the diameter d at the top of each well 68.

To dispense aliquots of blood into a well 68, the micropipet 50 is maneuvered so that the capillary tube 14 extending from the case 54 passes through the corresponding opening 80 in the positioning cover 64. The end 56 of the case 54 comes into contact with the upper surface 88 of the positioning cover 64, thereby stopping the tip 42 of the capillary tube 14 at a distance Δ above the top of the collection media. The distance Δ is selected to allow the dispensed blood droplet at the tip 42 to come into contact with the upper surface 84 of the collection media while preventing the wicking problem described above if the tip 42 were to be in direct contact with the surface of the collection media.

Preferably the positioning cover 64 is fabricated from a transparent material so that the user can view the dispensed blood during the spotting process. The positioning cover 64 also functions as a protective layer. The openings 80 in the cover are preferably sealed with a thin protective media, such as plastic film, to protect the device 60 before spotting into the wells 68. At the time of spotting the seals are removed, or broken with the tip 42 of the capillary tube 14.

Although described above as a cylindrical case 54, in alternative embodiments the dispensing stage has a different form. For example, the dispensing stage can include any structure that extends radially from the outer surface of the capillary tube 14 at an axial position that achieves the desired separation distance Δ between the tip 42 of the capillary tube 14 and the upper surface 84 of the collection media.

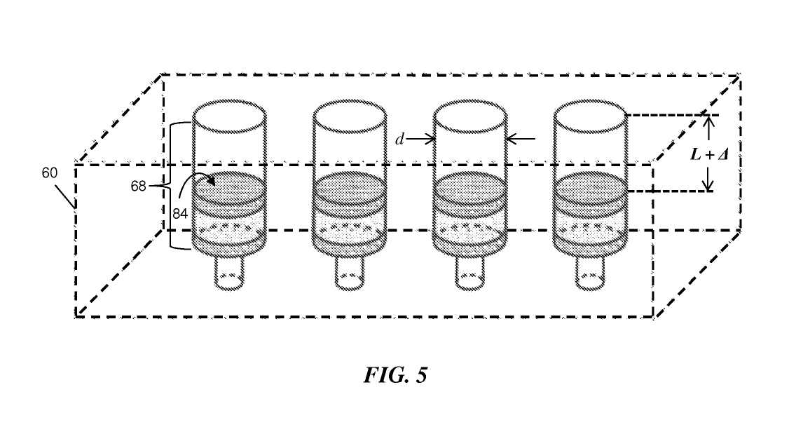

FIG. 5 shows an alternative embodiment in which the four well device 60 is the dispensing structure. The diameter d at the top of the wells 68 is less than the diameter c of the case 54. In this embodiment, a positioning cover is unnecessary. The length L+Δ from the top of the well to the upper surface 84 of the collection media is maintained thereby preventing the tip 42 of the capillary tube 14 from coming into contact with the collection media. The top surface of the well device can be sealed with a thin protective media to protect the wells 68 before implementing the spotting procedure.

In other embodiments, the micropipet includes a case that is configured for use with other types of collection devices, such as DBS cards. In one embodiment, a box-shaped positioning cover having an open bottom can be placed over the DBS card and properly positioned with respect to the card using alignment features. The top of the box-shaped cover has openings to pass the portion of the capillary tube 14 extending from the case 54.

The height of the box-shaped cover and the thickness of the wall having the openings are selected to achieve the desired offset Δ between the tip 42 of the capillary tube 14 and the upper surface of the collection media on the DBS card.

While the invention has been shown and described with reference to specific embodiments, it should be understood by those skilled in the art that various changes in form and detail may be made therein without departing from the spirit and scope of the invention as recited in the accompanying claims For example, various embodiments of the micropipet are described as dispensing three or four aliquots, it should be recognized that in other embodiments the micropipet can be configured to deliver other numbers of aliquots from a single sample collection.

What is claimed is:

1. A pipet comprising:
a capillary tube having a bore;
a plunger having a shaft with a first end disposed in the bore of the capillary tube and a second end opposite the first end configured for depressing by a user;
a plug disposed on the shaft of the plunger inside the bore of the capillary tube and in slidable engagement with a bore surface to provide a seal therebetween; and
a plunger stop mechanism in cooperative engagement with the shaft of the plunger to limit movement of the shaft in an axial direction in equal incremental distances.

2. The pipet of claim 1 wherein the shaft has a plurality of circumferential grooves each having an equidistant axial separation from a neighboring one of the other circumferential grooves and wherein the plunger stop mechanism comprises a spring-loaded plunger stop configured to engage one of the circumferential grooves.

3. The pipet of claim 2 wherein the spring-loaded plunger stop comprises an extension shaped to engage one of the circumferential grooves.

4. The pipet of claim 1 wherein the shaft has guide groove having a plurality of longitudinal groove segments and a plurality of circumferential groove segments on an outer surface of the shaft, each neighboring pair of longitudinal groove segments being in communication with each other through one of the circumferential groove segments, the pipet further comprising an extension disposed on the capillary tube and protruding radially inward in engagement with the guide groove.

5. The pipet of claim 4 wherein the extension is disposed at an end of the capillary tube.

6. The pipet of claim 1 wherein the shaft has guide groove having a plurality of longitudinal groove segments and a plurality of circumferential groove segments on an outer surface of the shaft, each neighboring pair of longitudinal groove segments being in communication with each other through one of the circumferential groove segments, the pipet further comprising a housing substantially enclosing the capillary tube, the housing having an extension protruding radially inward in engagement with the guide groove.

7. A pipet, comprising:
a capillary tube having a bore;
a plunger having a shaft with a first end disposed in the bore of the capillary tube and a second end opposite the first end configured for depressing by a user;
a plug disposed on the shaft of the plunger inside the bore of the capillary tube and in slidable engagement with a bore surface to provide a seal therebetween; and
a dispensing stage surrounding a first portion of a length of the capillary tube, wherein an end of the dispensing stage is configured to engage a surface of a dispensing structure having an opening therein when a second portion of the length of the capillary tube extends through the opening by a predetermined distance.

8. The pipet of claim 7 wherein the dispensing stage has a cylindrical shape.

9. The pipet of claim 7 further comprising the dispensing structure.

10. The pipet of claim 9 wherein the dispensing structure is transparent.

11. The pipet of claim 9 wherein the dispensing structure includes a protective film disposed over the opening.

12. The pipet of claim 9 wherein the dispensing structure is a positioning cover configured as a plate having an upper surface, a lower surface and a plurality of openings therebetween, the plate having a thickness predetermined to maintain a desired separation of a tip of the capillary tube from a collection medium when the end of the dispensing stage is in engagement with the upper surface of the plate.

13. The pipet of claim 9 wherein the dispensing structure is a multiple well device, wherein a desired separation of a tip of the capillary tube from a collection medium is maintained when the end of the dispensing stage is in engagement with an upper surface of the multiple well device.

14. The pipet of claim 9 wherein the dispensing structure is a positioning cover having a plurality of walls configured in an open-ended box shape, one of the walls having a plurality of openings therethrough.
